(19) United States
(12) Patent Application Publication
(10) Pub. No.: US 2009/0158433 A1
(43) Pub. Date: Jun. 18, 2009

(54) Method and Apparatus to Facilitate Generating Worm-Detection Signatures Using Data Packet Field Lengths

(75) Inventors: Zhichun LI, Evanston, IL (US); Yan CHEN, Evanson, IL (US); Lanjia WANG, Evanson, IL (US); Zhi FU, Lake Zurich, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/958,760

(22) Filed: Dec. 18, 2007

(51) Int. Cl. G06F 15/18

(52) U.S. Cl. 726/24

(57) ABSTRACT

Network-level data traffic comprising data packets, wherein at least some of the data packets have at least one field of unbounded length, are received (101). A worm-detection signature is then generated (102) as a function, at least in part, of the lengths of particular data packet fields. So configured, these teachings are particularly suitable for use in detecting worms that seek to exploit the use of an unbounded field in a data packet to overwhelm buffer memory in a receiving network element as a basis for installing the worm's code.

### TECHNICAL FIELD

This invention relates generally to the detection of network vectored worms.

### BACKGROUND

Malicious software of various kinds are known in the art. These include, for example, worms. A worm is typically understood to comprise a program that is self-contained and which, when run, has the ability to spread itself to other systems. In essence, a worm is a virus that doesn't infect other programs; rather, it acts independently, seeking to spread to other computers connected to its current host. Worms tend to spread over network connections and can cause significant and abrupt platform and network disruption. Worms are capable of causing considerable economic loss in a relatively short period of time (often measured in minutes rather than hours or days).

Intrusion detection systems of various kinds are known or have been proposed that attempt to deal in a fully or largely automated manner with defending a given network against such threats. This, in turn, depends upon an ability to reliably (and quickly) detect the presence of a worm during an early phase of worm propagation (before that worm has infected and damaged or usurped the various network elements as comprise the defended network). Detecting malicious programs typically depends upon known byte patterns known as signatures. Unfortunately, many such approaches can be foiled through the use of polymorphic worms that change, for example, their byte sequence with every successive infection/point of propagation.

So-called vulnerability-based signature generation schemes, which attempt to address such challenges, are typically host based and cannot be readily and usefully applied at the network router/gateway level as they tend to require explicit code execution or the source/binary code of the vulnerable program to facilitate their analysis. Unfortunately, such requirements are typically too slow to suitably counteract the fast propagation of a worm through a network.

So-called exploit-based schemes are network based and tend to operate more quickly than vulnerability-based signature generation schemes. These schemes, however, tend to be content based, which aims to exploit the residual similarity in the byte sequences of different instances of polymorphic worms. However, various attacks have been proposed to evade the content-based signatures. As a result, these schemes tend to be less accurate and more easily avoided by a dedicated worm source.

### BRIEF DESCRIPTION OF THE DRAWINGS

The above needs are at least partially met through provision of the method and apparatus to facilitate generating worm-detection signatures using data packet field lengths described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, network-level data traffic comprising data packets, wherein at least some of the data packets have at least one field of unbounded length, are received. A worm-detection signature is then generated as a function, at least in part, of the lengths of particular data packet fields. So configured, these teachings are particularly suitable for use in detecting worms that seek to exploit the use of an unbounded field in a data packet to overwhelm buffer memory in a receiving network element as a basis for installing the worm's code.

By one approach, this can comprise using a plurality of normal traffic field length examples and a plurality of suspicious traffic field length examples by processing such examples to identify at least one candidate field length signature as a function, at least in part, of at least tending to avoid false positive identifications.

If desired, these teachings will further provide for processing this candidate field length signature to determine a corresponding score of field length value, which score rates the quality of the field length value as signature in terms of the tendency of the candidate signature to reduce false positives and to improve true positive identifications. One or more additional candidate traffic field length signatures for a same field (such as, but not limited to, suspicious traffic field length examples that are larger in value than the already identified candidate field length signature) can then be similarly processed to determine at least a second corresponding score of field length value such that these various corresponding scores can be compared to identify a best performing candidate traffic field length signature.

By one approach, these teachings will then further provide for processing at least one interpolated suspicious traffic field length example between this best performing candidate and another candidate (such as one of the suspicious traffic field length examples) to thereby determine yet another corresponding score that again evaluates the interpolated example's ability in reducing false positive identifications and improving true positive identifications. These scores can then again be employed to identify a resultant best performing suspicious traffic field length signature.

Such steps can be employed, if desired, for each of a plurality of different data packet fields to thereby provide a plurality of respectively best performing signatures. A particular subset of this plurality (such as, for example, a particular one or a particular pair) can then be identified for use as a worm-detection signature.

Those skilled in the art will recognize and appreciate that these teachings are readily and usefully applicable against a variety of worms that seek to exploit unbounded-length data packet fields including polymorphic worms that will change the precise content of such fields from one generation of worm to the next. Such approaches are well suited to network-level implementation and can be applied with respect to network traffic observations without a need to understand the underlying intended application(s). So configured, a network-based intrusion detection system can relatively quickly detect even a brand new worm and provide a corresponding signature that will serve to successfully identify worm traffic to facilitate the control of such traffic. Those skilled in the art will appreciate that these teachings achieve the automated and rapid generation of accurate and genuinely useful worm-detection signatures in a relatively short period of time.

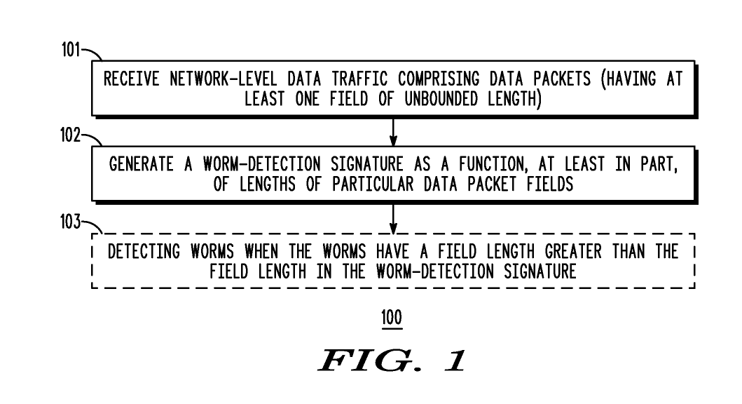

These and other benefits may become clearer upon making a thorough review and study of the following detailed description. Referring now to the drawings, and in particular to FIG. 1, an illustrative process that is compatible with many of these teachings will be presented.

Pursuant to this process 100, network-level data traffic comprising data packets is received 101. “Network-level” will be understood to refer to traffic that is in the process of vectoring from a source platform to a destination platform and does not include, for example, data traffic that has arrived at a given destination computer but which has not yet been received and processed by an application that resides at that destination computer. “Network-level” traffic examples might include traffic passing through a network gateway, a router, a wireless network base station, a mobile switching center, and so forth.

By one approach, at least some of these data packets have at least one field of unbounded length. Numerous protocols are known in the art that provide for such fields and others are likely to be developed going forward. These teachings are not particularly sensitive to the use of any particular protocol in this regard; rather, these teachings are likely suitable for use with essentially any data packets having one or more fields of essentially unbounded length. It will be understood that such data packets may also (and likely will) include one or more fields having a specifically bounded length.

This incoming network-level data traffic is preferably processed in order to segregate this traffic into either of at least two categories; normal traffic and suspicious traffic. This characterization activity can be based upon any existing worm-classifier technique of choice if desired. Such techniques and their manner of employment are well known in the art and require no further explanation here.

These incoming data packets (of both pools of classified content) are further preferably parsed in order to differentiate between and amongst their various fields. This can particularly comprise, if desired, identifying and segregating the aforementioned fields of unbounded length in order to render those fields readily available for the processing described herein. Such parsing techniques are also well known in the art.

This process 100 then generally provides for generating 102 at least one worm-detection signature as a function, at least in part, of lengths of particular data packet fields (typically at least including the aforementioned fields of unbounded length). This can specifically include, if desired, generating one or more polymorphic worm-detection signatures as a function of such data packet fields.

Such signatures, once generated, can be employed as desired. This can optionally include, for example, using such signatures to detect 103 worms when the worms have a field length (for a particular field) greater than the field length in the worm-detection signature. For example, when a given worm-detection signature comprises a value of 300 bytes for a particular corresponding identified field, this optional step can comprise identifying a given data packet as comprising worm content when this particular unbounded field in that data packet exceeds 300 bytes in length.

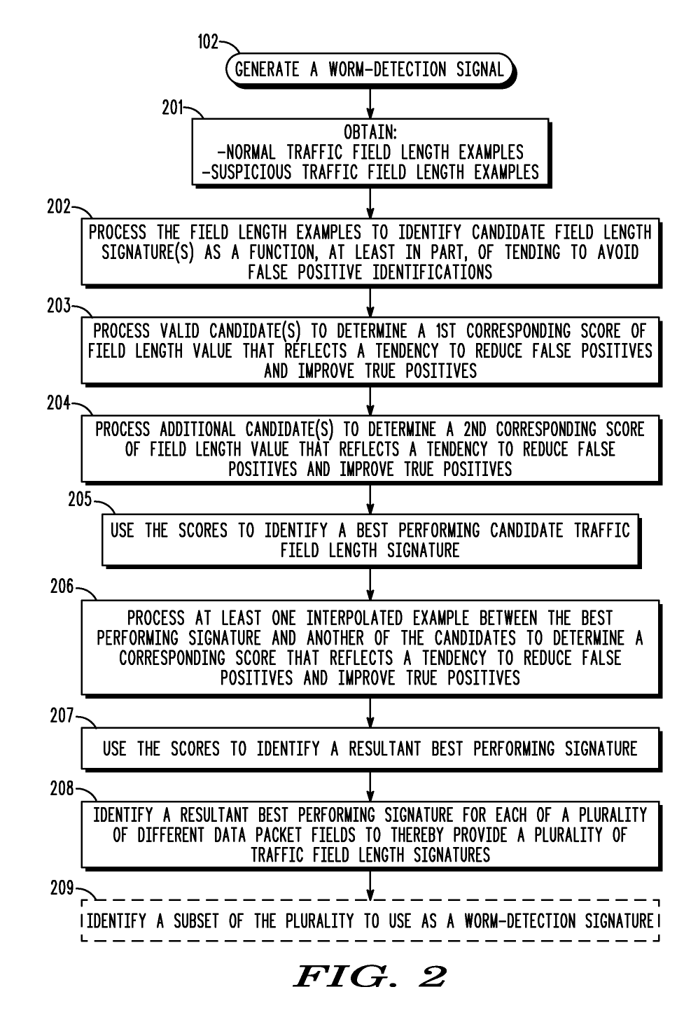

There are various ways by which such a worm-detection signature can be generated. Referring now to FIG. 2, some particular approaches in this regard will be described by way of illustration and not by way of limitation.

As alluded to above, such a process can include obtaining 201 a plurality of normal traffic field length examples and a plurality of suspicious traffic field length examples. Such examples can be obtained on an occasional basis if desired or can be more frequently and dynamically obtained from an internal and/or external source(s) of choice. By one approach, if desired, the distinction between “normal” and “suspicious” can be based, at least in part, upon use of other worm classification techniques such as, but not limited to, worm classification techniques that rely upon traffic pattern anomaly detection. (Those skilled in the art will recognize that existing worm classification techniques are not absolutely perfect and hence the use of the word “suspicious” in these descriptive materials.)

This process can then provide for processing 202 these pluralities of field length examples to identify at least one candidate field length signature as a function, at least in part, of at least tending to avoid false positive identifications. That is, the field length values exemplified by the examples in the aforementioned pools of normal and suspicious traffic can each be vetted as a worm-detection signature value by assessing, in a relative and comparative sense, how well that particular value tends to avoid including false positive identifications that exceed, for example, some basic requirement while tending to include true positives in a manner that equals or exceeds some corresponding requirement to thereby initially vet the performance of each candidate field length value with respect to its detection coverage.

This at least one resultant candidate traffic field length signature can then be processed 203 to determine a corresponding score. This score can comprise a score of the field length value that reflects the aforementioned tendency of the corresponding candidate traffic field length signature to tend to reduce false positive identifications while also tending to improve true positive identifications. Additional candidate traffic field length signatures can also be processed 204 to similarly determine their corresponding scores in this regard. By one approach, if desired, this can comprise processing all additional suspicious traffic field length examples that are larger in value than the resultant candidate traffic field length signature to determine these additional corresponding scores.

To illustrate by way of a non-limiting example, if the resultant candidate traffic field signature were “135” in a given instance, this activity could comprise developing a score for a first suspicious traffic field length example having a field length of “153” and a second suspicious traffic field length example having a field length of “161” (as both of these values are greater than “135”) while not developing such a score for a third suspicious traffic field length example having a field length of “121” (as “121” is less than “135”).

This, in turn, permits using 205 these scores to thereby identify a best performing candidate traffic field length signature. This might comprise, for example, comparing these scores against one another to identify a best score (which might be, for example, a highest score (or a lowest score, depending upon the nature of the score itself).

At this point, if desired, the resultant identified best performing candidate traffic field length signature can serve as a worm-detection signature with a fair amount of confidence. These teachings will also accommodate, however, further vetting and refinement in these regards. For example, and still referring to FIG. 2, this process 100 will further optionally accommodate processing 206 at least one interpolated suspicious traffic field length example between the best performing candidate traffic field length signature and another of the candidate traffic field length signatures to thereby again determine a corresponding score that reflects a tendency of the interpolated suspicious traffic field length example to tend to reduce false positive identifications while also tending to improving true positive identifications. To illustrate by way of a non-limiting example, this might comprise creating an interpolated field length value of “140” when the best performing signature has a value of “135” and the next largest candidate signature has a value of “145” and then assessing the worm-detection performance score as corresponds to that field length value.

This activity can be repeated as desired to generate and assess as many interpolated field length examples as desired. By one approach, for example, every integer increment between the best performing value and the bounding value can be assessed in this manner. To illustrate, if the range values are “135” and “140,” the interpolated values could comprise “136,” “137,” “138,” and “139.” Other choices in this regard are of course possible. For example, by one approach, no more than about half of the available incremental integer values might be assessed in the manner. Such choices might be based, for example, upon the corresponding computational complexity and any limitations in that regard which may apply in a given application setting.

In any event, this process 100 can then provide for using 207 these scores to now identify a resultant best performing suspicious traffic field length signature (which may comprise one of the original field length examples or may now comprise one of the interpolated field length examples).

Those skilled in the art will recognize and appreciate that these teachings provide an effective and efficient mechanism and process to identify a particular field length value that will reliably detect worms while simultaneously avoiding identifying innocent content as comprising a worm. As described, these results are attained by selecting a particular unbounded field in a particular kind of data packet and then generating a field length signature of that particular unbounded field that can serve in this capacity. Those skilled in the art will understand, however, that more than one field can comprise an unbounded field and furthermore that data packets themselves can vary to some extent with respect to their defining frame structure.

With this in mind, and again if desired, this process 100 will further optionally accommodate essentially repeating the aforementioned steps for other unbounded fields. This activity is succinctly represented in FIG. 2 as an overall step of identifying 208 a resultant best performing suspicious traffic field length signature for each of a plurality of different data packet fields to thereby provide a plurality of suspicious traffic field length signatures. This can then lead to identifying 209 a subset of the suspicious traffic field length signatures to use as a worm-detection signature.

This might comprise, for example, identifying a particular one of the suspicious traffic field length signatures that tends to be the most inclusive of true positive identifications. This primary selection can then be supplemented, if desired, by identifying a particular one of the suspicious traffic field length signatures that tends to most fully include any remaining true positive identifications that are not identified by this primary selection. This pair of selected signatures could then be used in combination with one another as joint worm-detection signatures. Such an approach could be extended, if desired, to include a third such supplemental signature (or more) as appropriate. However, those skilled in the art will understand that too many length signatures will cause false positives and thus one may only wish to include a sufficient number of length signatures to meet some desired level of comprehensive coverage with minimized false positives.

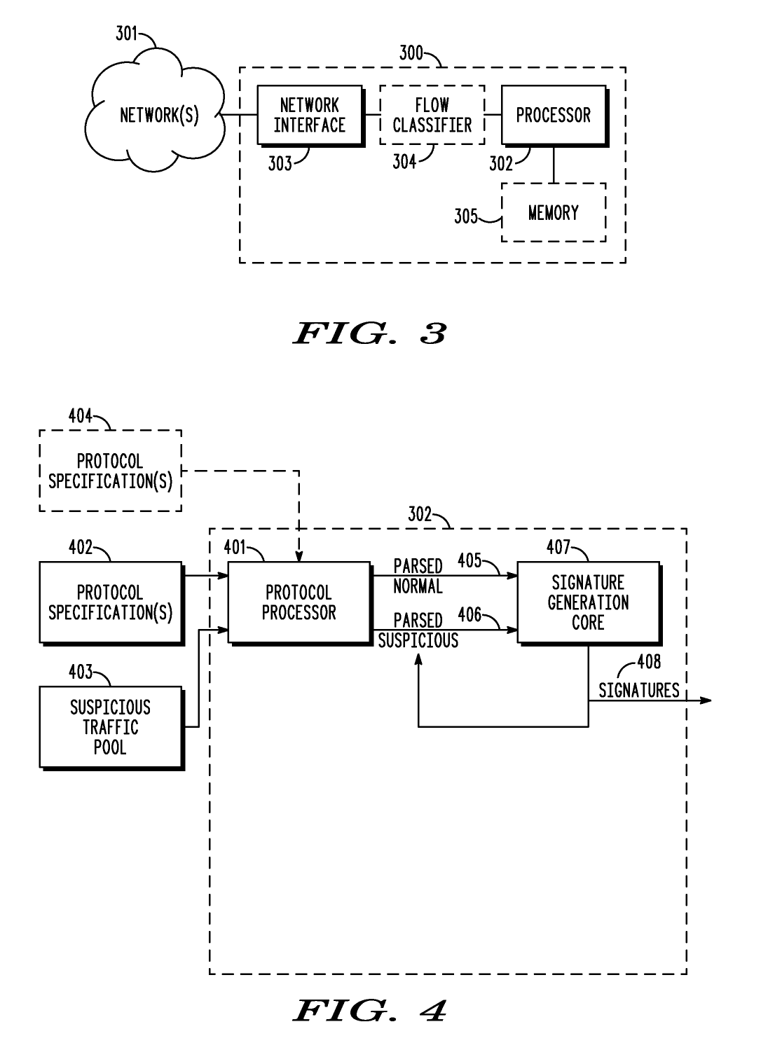

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative generalized approach to such a platform will now be provided.

The apparatus 300 can generally comprise a network-level network element such as a gateway, a router, a wireless network base station, a mobile switching center, and the like. This apparatus 300 can generally comprise a processor 302 and can be configured and arranged to receive network-level data traffic from a network 301 (or networks) via a network interface 303. As noted above, this network level data traffic can comprise, at least in part, at least some data packets having at least one field of unbounded length. There are numerous network interfaces known in the art that will suffice for such purposes. As these teachings are not overly sensitive to the selection of any particular choice or approach in this regard (other than ensuring that the network interface operate compatibly with the network(s) 301 as pertain to a given application setting), further elaboration regarding this interface need not be presented here.

As noted above, the incoming network-level data traffic can be classified as being normal or suspicious and can further be parsed in order to segregate the field or fields of interest prior to effecting the present teachings. If desired, a flow classifier 304 can be operably coupled between the network interface 303 and the processor 302 to provide this functionality. Such tasks and their corresponding enabling platforms are well known in the art and require no further description here.

The processor 302 can comprise a hard-wired platform or can comprise a partially or wholly programmable platform as are known in the art. Such architectural options are well understood by skilled artisans and require no further explanation here. This processor 302 can be configured and arranged (via, for example, corresponding programming) to carry out one or more of the steps, actions, and/or functions as are otherwise described herein. This can comprise, for example, configuring and arranging the processor 302 to generate a worm-detection signature as a function, at least in part, of lengths of particular data packet fields as described herein.

Referring now to FIG. 4, an illustrative example in this regard will be presented. Those skilled in the art will recognize and understand that this example is intended to serve only in an illustrative capacity and is not intended to comprise an exhaustive listing of all possibilities in this regard. In this example, the processor 302 includes a protocol processor 401 that receives data packets from a normal traffic pool 402 and a suspicious traffic pool 403. By one approach, this content may be provided, for example, by the aforementioned flow classifier 304.

This protocol processor 401 may also have optional external access, if desired, to one or more protocol specifications 404 that define, for example, the field structures of these data packets or the protocol processor 401 may have local access to such information. For most Internet protocols and applications, the aforementioned protocol specifications can be prepared based on the corresponding standards such as, for example, appropriate Internet Engineering Task Force (IETF) Request for Comments (RFCs) as are very well known in the art.

In either case, the protocol processor 401 parses these data packets in order to provide selected parsed content as an output. This can comprise, as shown, parsed normal fields 405 and parsed suspicious fields 406. Binpac, a known powerful protocol parsing tool, can serve well for these protocol parsing needs. With binpac, a protocol and its parsing requirement are described in a script. Binpac then uses the script as input and automatically generates the parser for parsing the protocol into different fields. The length parsing binpac script focuses only on extracting lengths for variable-length fields.

By one approach, the protocol processor 401 generates field identification/length pairs for all flows in the normal traffic pool and the suspicious traffic pool respectively. A signature generation core 407 can receive these incoming parsed fields 405 and 406 and employ the teachings set forth herein to generate one or more corresponding worm-detection signatures 408. By one approach, an algorithm of choice (such as is described above) can serve to generate these length-based signatures.

In a first step of the algorithm, the signature generation core 407 makes a first selection of the fields that are possible to be signature candidates. This action effectively limits the search space. Two parameters representing False Positives and Coverage are respectively set as the input: FP 0 and COV 0, which indicate the most basic requirement on the false positives and detection coverage. For example, one can choose FP 0=1% and COV 0=5%. This first step can be represented as follows:

Algorithm Step 1 Field filtering (M, N)

S ← φ;
for field fⱼ = 1 to K

find lⱼ such that $\frac{\vert {N}_{lj} \vert}{\vert N \vert} \leq {FP}_{0} < \frac{\vert {N}_{lj - 1} \vert}{\vert N \vert} ;$
$if \frac{\vert {M}_{lj} \vert}{\vert M \vert} \geq {COV}_{0}$

S ← S ∪ {(fⱼ, lⱼ)};

end

end
Output S;

where N represents the normal pool, M represents the suspicious pool, (fᵢ, lᵢ) represents the field ID and candidate length signature, Nᵢⱼ denotes flows detected by signature (fⱼ, lⱼ) in normal pool N, and S represents the candidate length signature set.

For a protocol with K fields, given a parsed normal pool set of (fⱼ, lⱼ), for each field j, there are |N| lengths, and a parsed suspicious pool set of (fⱼ, lⱼ) for each field j, there are |M| lengths. In this illustrative example one can first sort lengths for every field for both the normal pool and the suspicious pool respectively.

Those skilled in the art will recognize that, initially, the candidate signature set is empty. Then in the loop, first from the normal pool and for each field j, one can find a length so that the flows detected by the length are less than or equal to FP 0, and the flows detected by length-1 (i.e., that length reduced by “1”) will be greater than FP 0. (It may be noted that, for any length, flows detected in the normal pool will be false positive, assuming the normal pool is almost all comprised of normal traffic. It is very hard for attackers to inject a significant amount of noise into the normal pool as the normal pool can be generated over a very long time.)

For example, for field fⱼ, there are sorted lengths corresponding to different protocol messages as (20, 25, . . . , 49, 50) in the normal pool and (40, 100, . . . , 160) in the suspicious pool. For the sake of example and simplicity, one may assume here that there are 100 flows each for the normal and suspicious pools. (Those skilled in the art will recognize and understand that in an ordinary application setting, the normal pool should have more flows than the suspicious pool.) Assuming these quantities of flows, the length will be 50 because the false positives generated by length 50 in the normal pool will be 0.01 and the false positives by length 50−1=49 will be greater than 0.01.

During the loop's second part, using 50 as a candidate signature, all flows with lengths greater than 50 will be detected so that the coverage is greater than COV 0. The length 50 will accordingly be added to the candidate signature set.

In this first step, the algorithm added all possible candidates that meet the most basic requirement of FP 0 and COV 0. FP0=0.001 for the false positive should be small. COV 0 is chosen to be very small initially because attackers may inject a lot of noise to the suspicious pool by imitating worm behaviors. In a case there is a lot of normal traffic in the suspicious pool, the initial coverage is picked to be conservatively very small. These teachings may then provide for further optimizing the value in subsequent steps.

These teachings provide for processing each field separately. According to FP0, a signature length can be determined, by sorting and searching, in O(|N| log |N|) time. If the corresponding detection coverage on M is larger than COV 0, this field is taken as a signature candidate, and is passed to the next step of algorithm, which can be determined by O(|M|). The running time is O(K|N| log |N|+K|M|). Since usually |M| is far smaller than |N|, the overall time cost is O(K|N| log |N|).

This step actually makes use of the fact that, for buffer overflow worms, the true worm samples should have longer lengths on the vulnerable fields than the normal flows, and the noise which is not injected by attackers in M should have similar length distributions with the normal flows in N. If the coverage of true worm samples in the suspicious pool M is more than COV 0, the vulnerable field length with small false positive ratio FP 0 should have coverage larger than COV 0 in the suspicious pool. The COV 0 and FP 0 comprise very conservative estimates of the coverage and the false positive of the worm.

In a second step, these teachings provide for attempting to optimize the length value of each candidate signature to reduce false positives. The core 407 will try to find a best length with good coverage and/or the least false positives. The first step described above yields a very conservative estimate of coverage. In the second step, the core 407 attempts to find a longer length than the first step that will improve (by reducing) the false positives or improve (by increasing) the coverage. Sometimes a length can significantly improve coverage of the suspicious pool but can also increase false positives. For example, one length may have FP=0.01, COV=0.6, while another length has FP=0.02 and COV=0.9. These teachings will accommodate comparing different lengths to determine the better signature. As noted above, a score function can serve in this regard to facilitate comparing length signature candidates.

An algorithm to serve in this regard can appear as follows:

Algorithm Step 2 Signature Length Optimization
(S, M, N, Score(′, ′))

for signature (fⱼ, lⱼ) ε S

sort M^{f}^{ⱼ} in ascending order;
find m₀ such that xₘ_{₀}₋₁^{l}^{ⱼ} < lⱼ < xₘ_{₀}^{f}^{ⱼ};
max_score ← 0;
for m′ = m₀ to |M|

lⱼ^{′} ← x_{m′}^{f}^{ⱼ} − 1;
if (max_score < Score(COVₗ_{ⱼ}_{′}, FPₗ_{ⱼ}_{′}))

max_score ← Score(COVₗ_{ⱼ}_{′}, FPₗ_{ⱼ}_{′});
lⱼ ← lⱼ^{′};
m ← m′;

end

end
while $( {l}_{j} > \frac{{x}_{m - 1}^{lj} + {m}_{m}^{lj}}{2} )$

if (Score(COVₗ_{ⱼ}, FPₗ_{ⱼ}) = = Score(COVₗ_{ⱼ}₋₁, FPₗ_{ⱼ}₋₁))

lⱼ ← lⱼ − 1;

else

update S with lⱼ; break;

end

end

end
Output S;

In the above algorithm, with sorted and ascending lengths for field fⱼ, Xₘ[fⱼ] is the m^{th} length in the suspicious pool. For each signature candidate (fⱼ, lⱼ) in suspicious pool M with sorted ascending lengths for fⱼ, one can find a mₒ such that the length mₒ is greater than lⱼ. For instance, in the above simple example, and where the selected length in the first step is 50, then the Xₘₒ that is greater than 50 in the lengths for suspicious pool will be 100. Then in the loop, all lengths 100 and above will be tested for their efficacy based on a score function.

The score function in this example can be expressed as:

Score(COV, FP)=(1/logFP+1)*COV,

which works quite well in practice. For all lengths greater starting from Xₘₒ, one can calculate a corresponding score on a one-by-one basis until a best one has been identified.

The first loop in this approach picks a longer length value with a best score. With the length selected in the first loop, in the second loop, the core 407 can further optimize it by finding a smaller length with the same score. For example, using the previous simple example, step 1 finds length=50. At step2, the core 407 then tests all lengths longer than 50, starting from 100, and finds that the best score is with length 120. Then, in the second loop, the algorithm searches all interpolated values (incrementing by one) between 110 and 120 to find one value with the same score but which is less than 120.

At least one rationale for the second loop is as follows. Choosing a worm-detection signature length that is too close to the edge of the lengths of genuine worm flows is not necessarily a good choice, especially when the length distributions of normal field instances and of malicious field instances are well separated. So in the second loop of the algorithm Step 2, the process further decreases lⱼ until the score changes (by decreasing) or lⱼ reaches the median of two consecutive elements in Mᵢⱼ.

At this point in the process, the core 407 has typically developed a set of candidate field and length signatures. Too many length signatures, however, can cause a lot false positives. Therefore, in an optional final step, the core 407 can find an optimal smaller set of signature candidates to be the final signature set. Generally speaking, the more signatures used, the more false positives there are but with better coverage.

An algorithm to serve in this regard can be presented as follows:

Algorithm Step 3 Signature Pruning (S, M, N)

m ← |M|;
S₁ ← {e/e ε S; FPₑ = 0};
S₂ ← {e/e ε S; FPₑ > 0};
Ω ← φ;
LOOP1;
while (S₁ ≠ φ)

Find s ε S₁ such that $\frac{\vert {M}_{s} \vert}{m}$ is the maximum one in S₁;
If $( \frac{\vert {M}_{s} \vert}{m} \geq γ )$

Ω ← Ω ∪ {s};
S₁ ← S₁ − {s};
Remove all the samples which match s in M;

else

Break;

end

end
LOOP2;
while (S₂ ≠ φ)

Find s ε S₂ such that $\frac{\vert {M}_{s} \vert}{m}$ is the maximum one in S₂;
If $( \frac{\vert {M}_{s} \vert}{m} \geq γ )$

Ω ← Ω ∪ {s};
S₂ ← S₂ − {s};
Remove all the samples which match s in M;

else

Break;

end

end
Output Ω;

In the above algorithm, there are again two loops. Before the first loop, a preparation stage puts those candidate signatures that generate no false positives into S₁ and those that generate non-zero false positives into S₂. Initially final set Ω is empty. In loop1, the core 407 checks all candidates in S₁ and finds one with maximum coverage of the suspicious pool. If the coverage is greater than a pre-set parameter Y′, the core 407 then adds the signature to the final set. The loop ends when the core 407 cannot find any signature that can improve at least Y′ coverage. For some application settings, one may choose Y′=0.02.

Similarly in loop2, the core 407 can find signatures that can at least improve coverage by Y and include them in the final set as well. The selection can be based on the fact that usually one field signature dominates the coverage with other fields not helping much in this regard. With every round, the core 407 finds the one with the maximum coverage for the remaining flows in M, and includes that one only if it covers at least Y (e.g. 10%) of the remaining flows.

For example, in the signature set, if the core 407 first selects (field3,120) that covers 80% of the flows, then one can remove all samples which matched it in M. Then for the remaining 20% flows, the core 407 can check to see if the second best candidate can cover at least Y′ of the remaining flows. The second best will be selected only if it can cover Y′ of the remaining flows without causing any false positives.

Those skilled in the art will recognize and understand that such an apparatus 300 may be comprised of a plurality of physically distinct elements as is suggested by the illustrations shown in FIGS. 3 and 4. It is also possible, however, to view these illustrations as comprising logical views, in which case one or more of these elements can be enabled and realized via a shared platform. It will also be understood that such a shared platform may comprise a wholly or at least partially programmable platform as are known in the art.

Those skilled in the art will recognize and appreciate that these resultant length based signature(s) are simple to use. For example, field1.length>512 byte can serve as a signature to indicate that all messages with field1's length greater than 512 bytes should be dropped or quarantined. This length based signature is also hard to evade. Although attackers can change a byte sequence using a polymorphic engine the length of the sequence must at least equal some value in order to reliably exploit buffer overflow vulnerabilities of a receiving platform; that is, the worms have to keep the length of the particular field long in order to overflow the corresponding buffer for a successful attack to occur.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving network-level data traffic comprising data packets, wherein at least some of the data packets have at least one field of unbounded length;
generating a worm-detection signature as a function, at least in part, of lengths of particular data packet fields.

2. The method of claim 1 wherein generating a worm-detection signature as a function, at least in part, of lengths of particular data packet fields comprises, at least in part, generating a polymorphic worm-detection signature as a function, at least in part, of lengths of particular data packet fields.

3. The method of claim 1 wherein generating a worm-detection signature as a function, at least in part, of lengths of particular data packet fields comprises using a plurality of normal traffic field length examples and a plurality of suspicious traffic field length examples.

4. The method of claim 3 wherein generating a worm-detection signature as a function, at least in part, of lengths of particular data packet fields further comprises processing the plurality of normal traffic field length examples and the plurality of suspicious traffic field length examples to identify at least one candidate field length signature as a function, at least in part, of at least tending to avoid false positive identifications.

5. The method of claim 4 wherein generating a worm-detection signature as a function, at least in part, of lengths of particular data packet fields further comprises:
processing the at least one candidate traffic field length signature to determine a first corresponding score of field length value that reflects a tendency of the at least one candidate traffic field length signature to tend to reduce false positive identifications while also tending to improve true positive identifications;
processing at least one additional candidate traffic field length signature to determine a second corresponding score of field length value that reflects a tendency of the additional candidate traffic field length signature to tend to reduce false positive identifications while also tending to improve true positive identifications;
using the first and the second corresponding scores to identify a best performing candidate traffic field length signature.

6. The method of claim 5 wherein processing at least one additional candidate traffic field length signature to determine a second corresponding score that reflects a tendency of the additional candidate traffic field length signature to tend to reduce false positive identifications while also tending to improve true positive identifications comprises processing all additional suspicious traffic field length examples that are larger in value than the particular suspicious traffic field length example to determine additional corresponding scores that reflect a tendency of the additional suspicious traffic field length examples to each tend to avoid false positive identifications while also tending to include true positive identifications.

7. The method of claim 5 wherein generating a worm-detection signature as a function, at least in part, of lengths of particular data packet fields further comprises:
processing at least one interpolated suspicious traffic field length example between the best performing candidate traffic field length signature and another of the candidate traffic field length signature to determine a corresponding score that reflects a tendency of the interpolated suspicious traffic field length example to tend to reduce false positive identifications while also tending to improve true positive identifications;
using the scores to identify a resultant best performing suspicious traffic field length signature.

8. The method of claim 7 wherein generating a worm-detection signature as a function, at least in part, of lengths of particular data packet fields further comprises:
identifying a resultant best performing suspicious traffic field length signature for each of a plurality of different data packet fields to thereby provide a plurality of suspicious traffic field length signatures;
identifying a subset of the suspicious traffic field length signatures to use as a worm-detection signature.

9. The method of claim 8 wherein identifying a subset of the suspicious traffic field length signatures to use as a worm-detection signature comprises identifying a first one of the suspicious traffic field length signatures that tends to be most inclusive of true positive identifications.

10. The method of claim 9 wherein identifying a subset of the suspicious traffic field length signatures to use as a worm-detection signature further comprises identifying at least one additional one of the suspicious traffic field length signatures that tends to most fully include any remaining true positive identifications that are not identified by the first one of the suspicious traffic field length signatures.

11. An apparatus comprising:
a network interface configured and arranged to receive network-level data traffic comprising data packets, wherein at least some of the data packets have at least one field of unbounded length;
a processor operably coupled to the network interface and being configured and arranged to generate a worm-detection signature as a function, at least in part, of lengths of particular data packet fields.

12. The apparatus of claim 11 wherein the apparatus comprises at least one of:
a gateway;
a router;
a wireless network base station;
a mobile switching center.

13. The apparatus of claim 11 wherein the processor is further configured and arranged to generate a worm-detection signature as a function, at least in part, of lengths of particular data packet fields by using a plurality of normal traffic field length examples and a plurality of suspicious traffic field length examples.

14. The apparatus of claim 13 wherein the processor is further configured and arranged to generate a worm-detection signature as a function, at least in part, of lengths of particular data packet fields further by processing the plurality of normal traffic field length examples and the plurality of suspicious traffic field length examples to identify a particular suspicious traffic field length example as a function, at least in part, of tending to reduce false positive identifications.

15. The apparatus of claim 14 wherein the processor is further configured and arranged to generate a worm-detection signature as a function, at least in part, of lengths of particular data packet fields by:
processing the particular suspicious traffic field length example to determine a first corresponding score that reflects a tendency of the particular suspicious traffic field length example to tend to reduce false positive identifications while also tending to improve true positive identifications;
processing at least one additional suspicious traffic field length example to determine a second corresponding score that reflects a tendency of the additional suspicious traffic field length example to tend to reduce false positive identifications while also tending to improve true positive identifications;
using the first and the second corresponding scores to identify a best performing suspicious traffic field length example.

16. The apparatus of claim 15 wherein the processor is further configured and arranged to process at least one additional suspicious traffic field length example to determine a second corresponding score that reflects a tendency of the particular suspicious traffic field length example to tend to reduce false positive identifications while also tending to improve true positive identifications by processing all additional suspicious traffic field length examples that are larger in value than the particular suspicious traffic field length example to determine additional corresponding scores that reflect a tendency of the additional suspicious traffic field length examples to each tend to reduce false positive identifications while also tending to improve true positive identifications.

17. The apparatus of claim 15 wherein the processor is further configured and arranged to generate a worm-detection signature as a function, at least in part, of lengths of particular data packet fields by:
processing at least one interpolated suspicious traffic field length example between the best performing suspicious field length example and another of the suspicious field length examples to determine a corresponding score that reflects a tendency of the interpolated suspicious traffic field length example to tend to reduce false positive identifications while also tending to improve true positive identifications;
using the scores to identify a resultant best performing suspicious traffic field length signature.

18. The apparatus of claim 17 wherein the processor is further configured and arranged to generate a worm-detection signature as a function, at least in part, of lengths of particular data packet fields by:
identifying a resultant best performing suspicious traffic field length signature for each of a plurality of different data packet fields to thereby provide a plurality of suspicious traffic field length signatures;
identifying a subset of the suspicious traffic field length signatures to use as a worm-detection signature.

19. The apparatus of claim 18 wherein the processor is further configured and arranged to identify a subset of the suspicious traffic field length signatures to use as a worm-detection signature by identifying a first one of the suspicious traffic field length signatures that tends to be most inclusive of true positive identifications.

20. The apparatus of claim 19 wherein the processor is further configured and arranged to identify a subset of the suspicious traffic field length signatures to use as a worm-detection signature by identifying at least one additional one of the suspicious traffic field length signatures that tends to most fully include any remaining true positive identifications that are not identified by the first one of the suspicious traffic field length signatures.
